(19) United States
(12) Patent Application Publication
(10) Pub. No.: US 2017/0120724 A1
(43) Pub. Date: May 4, 2017

(54) CABIN TEMPERATURE SETTING AND DISPLAY METHOD AND SYSTEM

(71) Applicants: Hyundai America Technical Center, Inc, Superior Township, MI (US); Hyundai Motor Company, Seoul (KR); Kia Motors Corporation, Seoul (KR)

(72) Inventor: Devin Furse, Tehachapi, CA (US)

(21) Appl. No.: 14/925,388

(22) Filed: Oct. 28, 2015

(51) Int. Cl. B60H 1/00

(52) U.S. Cl. CPC B60H 1/00985

(57) ABSTRACT

A method includes: sensing a current cabin temperature in a cabin of a vehicle using a cabin temperature sensor; determining a desired cabin temperature based on input received via a cabin temperature setting means; displaying an indication of the desired cabin temperature on a display in the vehicle; displaying an indication of the current cabin temperature on the display; and updating the displayed indication of the current cabin temperature in real-time when a change of the current cabin temperature is sensed. The indication of the desired cabin temperature is displayed concurrently with and in substantial proximity to the indication of the current cabin temperature.

### BACKGROUND

(a) Technical Field

The present disclosure relates generally to automotive climate control systems, and more particularly, to a cabin temperature setting and display method and system.

(b) Background Art

Automotive climate control systems are designed to allow the driver and/or passengers of a vehicle to set and adjust the cabin temperature of the vehicle as desired. For example, an automatic temperature controller (or full automatic temperature controller (FATC)) may receive a user's input signal, along with various input signals from sensors, and control multiple actuators to maintain the user's desired temperature. The temperature inside the vehicle cabin, i.e., an enclosed space in the vehicle where the driver or passengers may be seated, can be set according to a variety of specific techniques, as are well-known in the art. The cabin temperature, however, may be affected by a number of factors, including solar loading (e.g., an increase in temperature in a space resulting from solar radiation, also known as solar gain), varying blower speeds and airflow amounts, cabin temperature inhomogeneity, and the like. Due to the above factors, it can be difficult to accurately or reliably measure the cabin temperature of a vehicle. Therefore, displaying the cabin temperature to the driver and/or passengers of the vehicle could produce a misleading effect.

Furthermore, most automotive climate control systems include a series of doors (e.g., temperature doors), through which air—typically, heated or cooled air—can flow. Actuators in the control system can control the position of the temperature doors, which thereby determines the path of air flow and, eventually, the cabin temperature. For instance, FIG. 1 illustrates an example climate control system 100, in which multiple temperature doors 110 are positioned. As shown in FIG. 1, the positioning of the temperature doors 110 affects the position from which air will blow, as well as the type of air that is blown. Actuators (not shown), which may be automatically controlled by the automatic temperature controller, can control various aspects of climate control system 100 by adjusting the positioning of the temperature doors 110 (e.g., by opening or closing various air flow passageways 120). For example, a mode actuator may adjust the temperature doors 110 to control the position from which air will blow (e.g., vent, floor or defrost), a blend actuator may adjust the temperature doors 110 to control the blending of warm and cold air, a circulate (or fresh) actuator may adjust the temperature doors 110 to control whether inside or outside air is used in the system, a heater actuator may adjust the temperature doors 110 to control heater flow, and so forth. Moreover, some vehicles have both driver-side and passenger-side temperature actuators to allow for dual temperature control. Notably though, the specific positioning of the temperature doors 110, as it is controlled by the actuators, is not conventionally displayed to the driver and/or passengers.

### SUMMARY OF THE DISCLOSURE

The present disclosure provides techniques for calculating and displaying the current cabin temperature and setting and displaying a desired cabin temperature. By concurrently displaying the current cabin temperature and desired cabin temperature, such that the current cabin temperature and the desired cabin temperature are displayed in substantial proximity to one another, and by updating the displayed current cabin temperature in-real time (e.g., as the current cabin temperature changes based on the desired cabin temperature), the user can see the current cabin temperature increase or decrease until it equals the set desired cabin temperature. As a result, the absolute value of the cabin temperature may be displayed, rather than merely displaying the cabin temperature relative to the setting.

The disclosed techniques also provide for displaying the position of temperature doors (or “blend doors”). Visualizing the position of the temperature doors may assist the user in understanding whether the cabin temperature could be improved if a different temperature or heating/cooling setting were selected. In other words, rather than a conventional, “black box”-like automatic temperature control system, where the temperature doors are automatically controlled without such actions being communicated, the user can learn useful information pertaining to the temperature door position that creates a more functional relationship between the user and the climate control system.

According to embodiments of the present disclosure, a method includes: sensing a current cabin temperature in a cabin of a vehicle using a cabin temperature sensor; determining a desired cabin temperature based on input received via a cabin temperature setting means; displaying an indication of the desired cabin temperature on a display in the vehicle; displaying an indication of the current cabin temperature on the display; and updating the displayed indication of the current cabin temperature in real-time when a change of the current cabin temperature is sensed. The indication of the desired cabin temperature is displayed concurrently with and in substantial proximity to the indication of the current cabin temperature.

The method may further include displaying the indication of the desired cabin temperature and the indication of the current cabin temperature according to a step-based display scheme including temperature steps displayed on the display. Each temperature step may represent a particular temperature within a temperature range.

The method may further include displaying the indication of the desired cabin temperature using a first indicator that corresponds to a first temperature step of the temperature steps; and displaying the indication of the current cabin temperature using a second indicator that corresponds to a second temperature step of the temperature steps.

The first temperature step and the second temperature step may be the same temperature step.

The first indicator may be a first icon and the second indicator may be a second icon different from the first icon.

The method may further include determining which temperature step of the temperature steps corresponds to the current cabin temperature based on the current cabin temperature sensed by the cabin temperature sensor, a total number of steps of the temperature steps, and a minimum and maximum temperature of the temperature range.

The determining of which temperature step corresponds to the current cabin temperature may be based further on a predetermined minimum and maximum temperature defining a temperature range within which the cabin of the vehicle is comfortable.

Each temperature step may represent a particular temperature within a temperature range according to the following equation:

$${{T}_{STEP} ( i )}_{i = 1}^{m} = {T}_{SET , MIN} + \frac{( i - 1 ) ( {T}_{SET , MAX} - {T}_{SET , MIN} )}{( m - 1 )} ,$$

where TSTEP(i) is a temperature at temperature step i, m is a total number of steps of the temperature steps, TSET,MIN is a minimum temperature in the temperature range, and TSET,MAX is a maximum temperature in the temperature range.

The method may further include displaying the indication of the desired cabin temperature using a first numerical value; and displaying the indication of the current cabin temperature using a second numerical value.

The method may further include determining a heating or cooling state of the vehicle; and displaying an indication of the heating or cooling state on the display. The indication of the heating or cooling state may be displayed concurrently with the indication of the desired cabin temperature and the indication of the current cabin temperature.

The method may further include determining the heating or cooling state based on a position of temperature doors in the vehicle.

The method may further include displaying the indication of the heating or cooling state using a color-based indicator.

The method may further include updating the displayed indication of the heating or cooling state in real-time when a change of the heating or cooling state is determined by altering a color of the color-based indicator.

The method may further include displaying the indication of the heating or cooling state according to a color-based display scheme including shades of color displayed on the display. Each shade of color may represent a particular heating or cooling state of a plurality of predetermined heating or cooling states.

An indication of a heating state may be displayed using a reddish-colored indicator, and an indication of a cooling state may be displayed using a bluish-colored indicator.

The determined heating or cooling state may substantially correspond to one of: maximum heating, partial heating, maximum cooling, partial cooling, and neutral.

The method may further include determining a blower state of the vehicle; and displaying an indication of the blower state on the display. The blower state may represent whether an air conditioning system or a heater system is active, and the indication of the blower state may be displayed concurrently with the indication of the desired cabin temperature and the indication of the current cabin temperature.

The method may further include displaying the indication of the blower state using a text-based indicator.

The method may further include determining a desired driver-side cabin temperature based on input received via a first cabin temperature setting means; determining a desired passenger-side cabin temperature based on input received via a second cabin temperature setting means; and displaying an indication of the desired driver-side cabin temperature and an indication of the desired passenger-side cabin temperature on the display.

Furthermore, according to embodiments of the present disclosure, a system includes: a cabin temperature sensor that senses a current cabin temperature in a cabin of a vehicle; a cabin temperature setting means that receives input indicative of a desired cabin temperature; a display in the vehicle that displays information; and a controller that controls the display and thereby causes the display to: i) display an indication of the desired cabin temperature, ii) display an indication of the current cabin temperature, and iii) update the displayed indication of the current cabin temperature in real-time when a change of the current cabin temperature is sensed. The indication of the desired cabin temperature is displayed concurrently with and in substantial proximity to the indication of the current cabin temperature.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example climate control system;

FIGS. 2A and 2B illustrate example graphical representations of a display for an automotive climate control system;

FIG. 3 illustrates an example graphical representation of a display where the desired cabin temperature is equivalent to the current cabin temperature;

FIG. 4 illustrates an example display incorporated in a vehicle dashboard; and

FIG. 5 illustrates an example simplified procedure for determining the temperature step that corresponds to the current cabin temperature.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. The term “coupled” denotes a physical relationship between two components whereby the components are either directly connected to one another or indirectly connected via one or more intermediary components.

It is understood that the term “vehicle” or “vehicular” or other similar term as used herein is inclusive of motor vehicles, in general, such as passenger automobiles including sports utility vehicles (SUV), buses, trucks, various commercial vehicles, watercraft including a variety of boats and ships, aircraft, and the like, and includes hybrid vehicles, electric vehicles, hybrid electric vehicles, hydrogen-powered vehicles and other alternative fuel vehicles (e.g., fuels derived from resources other than petroleum). As referred to herein, an electric vehicle (EV) is a vehicle that includes, as part of its locomotion capabilities, electrical power derived from a chargeable energy storage device (e.g., one or more rechargeable electrochemical cells or other type of battery). An EV is not limited to an automobile and may include motorcycles, carts, scooters, and the like. Furthermore, a hybrid vehicle is a vehicle that has two or more sources of power, for example both gasoline-based power and electric-based power (e.g., a hybrid electric vehicle (HEV)).

The term “user” may encompass any person substantially capable of interacting with an automotive climate control system, as it is defined herein, including, but not limited to a driver, a passenger, and the like. Also, the terms “climate control system,” “temperature control system,” and the like may be used herein interchangeably and represent technology for managing the climate inside a vehicle, e.g., the vehicle cabin, by controlling the degree of hotness/coolness therein, as would be well-known in the art.

Additionally, it is understood that one or more of the below methods, or aspects thereof, may be executed by at least one controller. The term “controller,” or “automatic temperature controller,” may refer to a hardware device that includes a memory and a processor. The memory is configured to store program instructions, and the processor is specifically programmed to execute the program instructions to perform one or more processes which are described further below. Moreover, it is understood that the below methods may be executed by wireless charging system comprising the controller, as described in detail below.

Referring now to embodiments of the present disclosure, the disclosed techniques allow for providing intuitive, easily understood feedback from an automotive climate control system. The feedback can facilitate the user's ability to accurately select a comfortable temperature setting, without overwhelming the user with unnecessary information. In particular, the current cabin temperature and desired cabin temperature may be concurrently displayed, such that the current cabin temperature and the desired cabin temperature are displayed in substantial proximity to one another, and the displayed current cabin temperature may be updated in-real time (e.g., as the current cabin temperature changes based on the desired cabin temperature). Thus, the user can see the current cabin temperature increase or decrease until it equals the set desired cabin temperature.

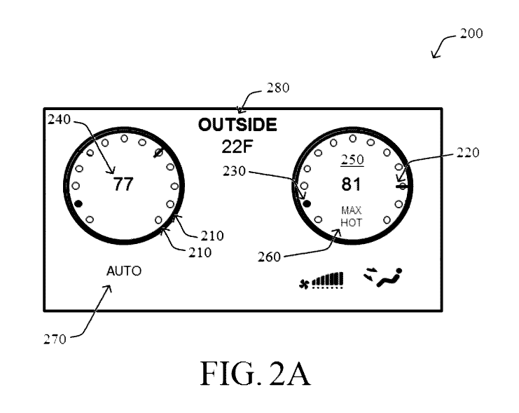

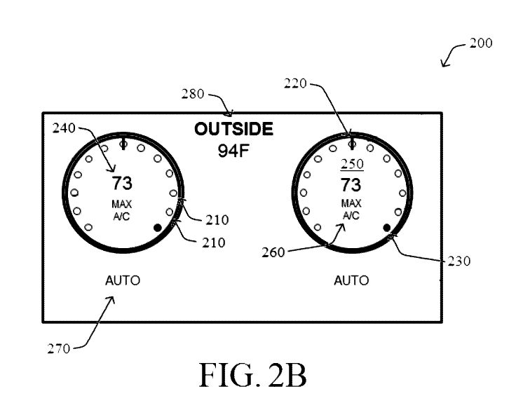

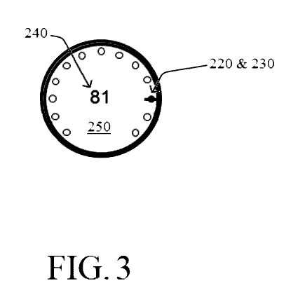

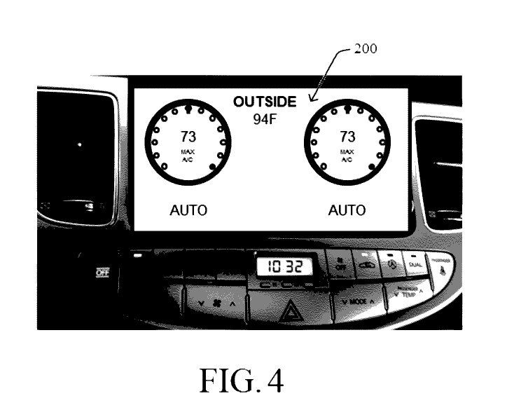

FIGS. 2A and 2B illustrate example graphical representations of a display for an automotive climate control system; FIG. 3 illustrates an example graphical representation of a display where the desired cabin temperature is equivalent to the current cabin temperature; and FIG. 4 illustrates an example display incorporated in a vehicle dashboard.

The display 200 may be implemented in a vehicle using any display means suitable for displaying information to the driver and/or passengers, such as, for example, a liquid crystal display (LCD) means, a light-emitting diode (LED) display means, a projection display means, and so forth. The display means on which the display 200 is implemented may optionally include touch-screen functionality. The display 200 may include a right and left display area, corresponding to a driver side and a passenger side, respectively, if the climate control system allows for independent adjustment of the driver-side and passenger-side climates. The display 200 may also be a heads-up display (HUD) to display information in the vehicle in a manner such that the driver is not required to look away from the road while driving. For instance, information may be projected onto a windshield or other substantially clear panel within the driver's primary line of sight.

As shown in FIGS. 2-4, the display 200 may display a plurality of indicators. As an example, the display 200 may display a step-based display scheme including temperature steps 210, where each temperature step 210 represents a particular temperature in a temperature range. The temperature steps 210 may be arranged in any suitable manner, such as a circular-like arrangement (e.g., mimicking a circular dial, as shown in FIGS. 2-4), an otherwise polygonal arrangement, a linear-like arrangement, an abstract arrangement, and so forth. Similarly, the temperature steps 210 may be depicted as any suitable object, such as a circular-like object (e.g., as shown in FIGS. 2-4), an otherwise polygonal object, a linear-like object, an abstractly shaped object, and so forth. Notably, the step-based display scheme shown in FIGS. 2-4 is for demonstration purposes only and should not be treated as limiting the display 200 to the depicted arrangement. Rather, the indicators displayed in the display 200 may be arranged in any suitable manner in accordance with the scope of the present claims. For example, the current and/or desired cabin temperature may be displayed in pictograph form (e.g., as a thermometer, where temperature steps are represented by lines/dashes on the thermometer).

In the case of the step-based display scheme, each temperature step 210 may be assigned a particular temperature in a temperature range, and there may be a fixed interval between adjacent temperature steps 210. The first displayed temperature step 210 may correspond to the lower limit of the temperature range, and the last displayed temperature step 210 may correspond to the upper limit of the temperature range, for example. To illustrate, where the temperature range is 61 degrees Fahrenheit to 85 degrees Fahrenheit, e.g., as determined by an automatic temperature controller (or full automatic temperature controller (FATC)), the first displayed temperature step 210 may correspond to 61 degrees and the last displayed temperature step 210 may correspond to 85 degrees. Therefore, since the total number of temperature steps 210 in FIGS. 2-4 is 13, the interval between each temperature step 210 may be two degrees, such that the second displayed temperature step 210 corresponds to 63 degrees, the third displayed temperature step 210 corresponds to 65 degrees, and so forth.

In this regard, each temperature step 210 may represent a particular temperature in a temperature range according to the following Equation 1:

$${{T}_{STEP} ( i )}_{i = 1}^{m} = {T}_{SET , MIN} + \frac{( i - 1 ) ( {T}_{SET , MAX} - {T}_{SET , MIN} )}{( m - 1 )} , \qquad [ Equation 1 ]$$

where T_{STEP}(i) is a temperature at temperature step i, m is a total number of steps of the temperature steps, T_{SET,MIN} is a minimum temperature in the temperature range, and T_{SET,MAX} is a maximum temperature in the temperature range. For example, in FIGS. 2-4, the total number of temperature steps 210 is 13, T_{SET,MIN} is 61 degrees Fahrenheit, and T_{SET,MAX} is 85 degrees Fahrenheit. Therefore, using Equation 1, T_{STEP}(5) (i.e., the temperature at the fifth temperature step 210) is 69 degrees, T_{STEP}(7) (i.e., the temperature at the seventh temperature step 210) is 73 degrees, and so forth. When employing the step-based display scheme, it should be understood that T_{STEP}(i) (i.e., the temperature at temperature step i) varies according to the number of temperature steps in the display, and the minimum and maximum temperature in the temperature range.

The display 200 may also display an indication of the desired cabin temperature 220 along with an indication of the current cabin temperature 230. The indication of the desired cabin temperature 220 may be displayed concurrently with and in substantial proximity to indication of the current cabin temperature 230, as shown in FIGS. 2-4. For instance, the indication of the desired cabin temperature 220 may be displayed using a first indicator that corresponds to a first temperature step 210, while the indication of the current cabin temperature 230 may be displayed using a second indicator that corresponds to a second temperature step 210. If the desired cabin temperature is equal to the current cabin temperature, the first and second temperature steps may be the same temperature step 210, e.g., as shown in FIG. 3.

The indications of the desired cabin temperature 220 and the current cabin temperature 230 may be displayed using various icons, for example. That is, the first indicator 220 (i.e., the indication of the desired cabin temperature) may be a first icon, and the second indicator 230 (i.e., the indication of the current cabin temperature) may be a second icon different from the first icon. As shown in FIGS. 2-4, the indication of the desired cabin temperature 220 may be a dash (at a first temperature step 210), while the indication of the current cabin temperature 230 may be a solid circle (at a second temperature step 210), based on the determined desired cabin temperature and current cabin temperature. If the desired cabin temperature is equal to the current cabin temperature, the first indicator 220 (e.g., dash) and the second indicator 230 (e.g., solid circle) may overlap one another at the same temperature step 210.

Notably, the indication of the desired cabin temperature 220 and the indication of the current cabin temperature 230, as depicted in FIGS. 2-4, are for demonstration purposes only and should not be treated as limiting the same to the depicted indications. Rather, the indications of the desired cabin temperature 220 and the current cabin temperature 230 may be depicted in any suitable manner in accordance with the scope of the present claims. For example, the indication of the desired cabin temperature 220 and the indication of the current cabin temperature 230 may be displayed using numerical values (e.g., a first and second numerical value, respectively). To this point, the numerical temperature indicator 240 may display the desired cabin temperature, as shown in FIGS. 2-4, in addition to, or lieu of, the indication of the desired cabin temperature 220. Thus, in FIGS. 2-4, the numerical temperature indicator 240 and the indication of the desired cabin temperature 220 correspond to the same value.

The desired cabin temperature may be determined, e.g., based on input received via a cabin temperature setting means. The determination may be performed by the automatic temperature controller (FATC). The cabin temperature setting means may be any device suitable for allowing a user to input a desired cabin temperature, such as, for example, a knob, a dial, a button, a lever, numerical keys, a touch-screen, a microphone (e.g., for voice-based commands), and so forth. Upon receiving and/or determining the user's desired cabin temperature, an indication of the desired cabin temperature may be displayed in the display 200, as explained above. Based on the desired cabin temperature, the FATC may control the automotive climate system (e.g., by adjusting the positioning of temperature doors 110, activating the heater or evaporator core, etc.) in order to conform the cabin temperature to the desired cabin temperature.

In addition, the current cabin temperature of the vehicle may be sensed, e.g., by a cabin temperature sensor (not shown). Upon sensing the current cabin temperature, an indication of the current cabin temperature may be displayed in the display 200, as explained above. Notably, as shown in FIGS. 2-4, the current cabin temperature can be displayed in comparison to the desired cabin temperature by concurrently displaying the two temperatures in proximity to one another. Moreover, the displayed indication of the current cabin temperature 230 can be updated (e.g., by the controller) in real-time when a change in the current cabin temperature is sensed. Therefore, the user can see the current cabin temperature increase or decrease until it equals the set desired cabin temperature.

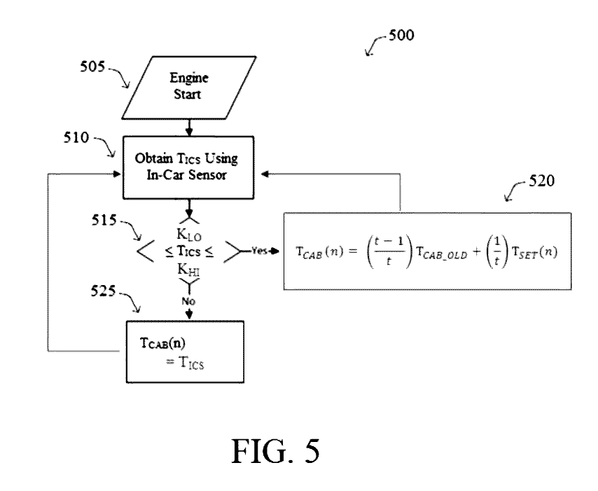

When displaying the indication of the current cabin temperature 230 using the step-based display scheme (as shown in FIGS. 2-4), or a similar display scheme, it may be determined which temperature step 210 of the temperature steps corresponds to the current cabin temperature. That is, a procedure may be executed (e.g., by the controller) to determine which temperature step 210 most closely corresponds to the sensed cabin temperature. In this regard, FIG. 5 illustrates an example simplified procedure for determining the temperature step that corresponds to the current cabin temperature. The procedure 500 may start at step 505, and continue to step 510, where, as described in greater detail above, an indication of the current cabin temperature 230 may be displayed using a step-based display scheme. For the purposes of the present disclosure and procedure 500, T_{ICS} is a temperature sensed by an in-car sensor (i.e., current cabin temperature), T_{SET}(n) is a set of user-selectable temperatures (i.e., desired cabin temperatures) in an n-zone climate system having n temperature steps, T_{SET,MIN/MAX} are the minimum/maximum temperature settings in the climate system, T_{CAB}(n) is a set of displayable cabin temperatures in the n-zone climate system (e.g., displayed as steps), t is the transition time for a step change in the displayed cabin temperature T_{CAB}, and m is the total number of temperature steps 210. For instance, T_{CAB}(1)=5 would indicate that the temperature being displayed in the first zone corresponds to the fifth temperature step 210. Multiple climate zones can exist in the vehicle; for example, a first zone may correspond to the driver, a second zone may correspond to a front passenger, a third zone may correspond to a rear passenger, and so forth. Additionally, K_{LO} and K_{HI} are tunable temperature parameters that can be functions of the ambient (i.e., outside) temperature, as well as the set temperature T_{SET}, as described in further detail below.

At step 505, the procedure 500 may be initialized upon start of the vehicle's engine. At step 510, T_{ICS} may be determined using an in-car temperature sensor. At step 515, it is determined whether T_{ICS} falls within the current K_{LO} and K_{HI} range (i.e., K_{LO}<T_{ICS}<K_{HI}). The values of K_{LO} and K_{HI} may represent a range of comfortable cabin temperatures, for example, and can be calibrated as desired. Various K_{LO} and K_{HI} values can be stored in a table and retrieved based on current conditions, such as the ambient (i.e., outside) temperature, as well as the set temperature T_{SET}.

If the currently sensed cabin temperature T_{ICS} is outside of K_{LO} and K_{HI}, the displayed temperature T_{CAB} is simply equal to T_{ICS} (step 525). Conversely, if T_{ICS} is within the range of K_{LO} and K_{HI}, T_{CAB} begins to transition to the set temperature T_{SET} (step 520). For instance, T_{CAB} can transition to T_{SET} according to the following Equation 2, as shown in step 520:

$${T}_{CAB} ( n ) = ( \frac{t - 1}{t} ) {T}_{CAB \_ OLD} + ( \frac{1}{t} ) {T}_{SET} ( n ) , \qquad [ Equation 2 ]$$

where T_{CAB}_{_}_{OLD} represents a previously displayed cabin temperature. After time t, if the T_{ICS} remains between K_{LO} and Kᵢᵢᵢ, T_{CAB} will equal T_{SET}. Notably, other filtering techniques or formulas can be utilized for transitioning T_{CAB} from the original T_{ICS} to T_{SET}, and the process described above is merely for the purpose of demonstration.

The procedure 500 illustratively ends when T_{CAB} equals T_{SET}. The techniques by which the steps of procedure 500 may be performed, as well as ancillary procedures and parameters, are described in detail above.

It should be noted that the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Even further, the illustrated steps may be modified in any suitable manner in accordance with the scope of the present claims.

In addition, a heating or cooling state of the automotive climate control system may be determined. The heating or cooling state may describe a state of the climate control system, such as whether the climate control system is heating or cooling the vehicle, the extent to which the vehicle is being heated or cooled, or whether the climate control system is in a neutral state. For instance, the heating or cooling state may substantially correspond to maximum heating, partial heating, maximum cooling, partial cooling, neutral, temperature blending, or the like.

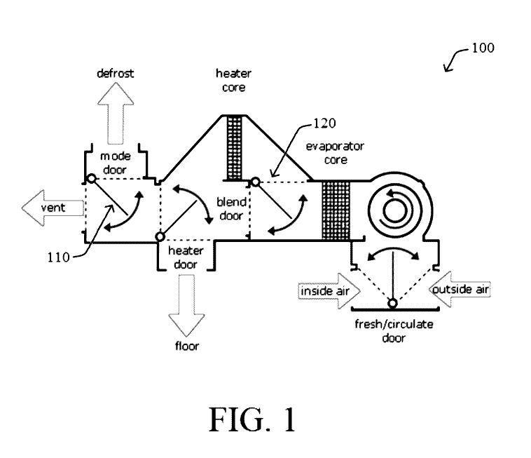

The heating or cooling state may be determined based on a position of the temperature doors 110 in the vehicle. Put another way, the positioning of the temperature doors 110 may affect whether the vehicle is being heated or cooled, and to what extent the heating or cooling occurs. For instance, as shown in FIG. 1, the climate control system controller can heat the vehicle by activating the heater core, adjusting the positioning of the temperature doors 110, and opening or closing the appropriate air flow passageways 120. Therefore, the heating or cooling state may be determined based on multiple input variables, including, for example, the currently sensed cabin temperature, the air conditioner state (i.e., on or off), the heater state, a minimum/maximum cabin temperature, and the like.

The display 200 may display an indication of the heating or cooling state 250 (e.g., as determined based on the position of the temperature doors 110). The indication of the heating or cooling state 250 may be displayed concurrently with the indication of the desired cabin temperature 220 and the indication of the current cabin temperature 230. Further, the indication of the heating or cooling state 250 can be displayed according to a color-based display scheme including shades of color displayed on the display, where each shade of color represents a particular heating or cooling state of a plurality of predetermined heating or cooling states (e.g., maximum heating, partial heating, maximum cooling, partial cooling, neutral, temperature blending, etc.). Of course, the automatic temperature controller can define any number of suitable heating or cooling states with corresponding shades of color.

In this regard, as shown in FIGS. 2-4, the indication of the heating or cooling state 250 may be displayed in the display 200 using a color-based indicator. In particular, the indication of the heating or cooling state 250 may include a shade of color (e.g., red, blue, etc.) that describes to the user the heating or cooling state of the climate control system. For example, an indication of a heating state may be displayed using a reddish-colored indicator, as shown in FIG. 2A, while an indication of a cooling state may be displayed using a bluish-colored indicator, as shown in FIG. 2B. As another example, a maximum heating state may be indicated using a red indicator, a partial heating state may be indicated using a light red indicator, a maximum cooling state may be indicated using a blue indicator, and a partial cooling state may be indicated using a light blue indicator. Thus, when the temperature door position is within a predefined range, e.g., as specified by the controller, the color for that range can be shown.

Moreover, the displayed indication of the heating or cooling state 250 may be updated in real-time when a change of the heating or cooling state is determined by altering a color of the color-based indicator. That is, the color-based indicator may smoothly transition from one color to another (due to a change in the heating or cooling state), in order to prevent a sudden and disruptive visual distraction to the driver. Notably, the indication of the heating or cooling state 250 may be displayed in any suitable manner, including a as background color in the display 200 along with various indicators (e.g., as shown in FIGS. 2-4), as an ancillary LED, or the like. Alternatively, the indication of the heating or cooling state 250 may be non-color-based, and may instead incorporate text (e.g., heating or cooling state text-based indicator 260), an image, a symbol, or any other suitable indicator. Or, a non-color-based indicator may accompany a color-based indicator.

Additional indicators may be displayed in the display 200, as is known in the art. For example, as shown in FIGS. 2-4, the message center 270 may be an area of the display 200 that display useful information to the user. As an example, when vehicle sensors detect high humidity conditions and the user has selected recirculation, the message center 270 may display “RECIRCULATION MAY CAUSE WINDOW FOGGING” or similar language. As another example, the message center 270 may indicate whether the automatic temperature control is on or off. Also, the message center 270 may provide instructions to the user. As an example, in very cold weather where the engine is cold and not able to provide heat, the message center may display “WAIT, ENGINE WARMING . . . ” or similar language.

Further, the outside temperature indicator 280 may indicate a current outside temperature. Even further, a blower state of the vehicle may be determined, and an indication of the blower state can be displayed on the display. The blower state represents whether an air conditioning system or a heater system is active, and the indication of the blower state can be displayed concurrently with the indication of the desired cabin temperature and the indication of the current cabin temperature. Notably, the layout of and displayed indicators in the display 200, as shown in FIGS. 2-4, are for demonstration purposes only and should not be treated as limiting the display 200 to the depicted arrangement. Rather, the particular indicators displayed in the display 200 may be selected and arranged in any suitable manner in accordance with the scope of the present claims.

Accordingly, techniques are described herein that improve the user experience of an automatic temperature control system by helping users to understand its function more clearly and to operate the same as intended by the design. To this end, additional information (e.g., current and desired cabin temperatures) can be displayed in the vehicle at a low cost, since no additional parts or wiring is necessary. In particular, the disclosed techniques can be applied in any automatic temperature control system using a cabin temperature sensor and any mechanism to ensure a variable outlet temperature. Further, the various indicators on the display 200 may enable the driver to quickly and easily differentiate the driver-side climate from the passenger-side climate (e.g., in the case of a dual climate control system).

While there have been shown and described illustrative embodiments that provide for a cabin temperature setting and display method and system, it is to be understood that various other adaptations and modifications may be made within the spirit and scope of the embodiments herein. For example, the embodiments have been primarily shown and described herein with relation to a particular display design and particular indicators (e.g., as depicted in FIGS. 2-4). However, the embodiments in their broader sense are not as limited. Rather, the embodiments may be modified in any suitable manner in accordance with the scope of the present claims.

The foregoing description has been directed to embodiments of the present disclosure. It will be apparent, however, that other variations and modifications may be made to the described embodiments, with the attainment of some or all of their advantages. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
sensing a current cabin temperature in a cabin of a vehicle using a cabin temperature sensor;
determining a desired cabin temperature based on input received via a cabin temperature setting means;
displaying an indication of the desired cabin temperature on a display in the vehicle;
displaying an indication of the current cabin temperature on the display; and
updating the displayed indication of the current cabin temperature in real-time when a change of the current cabin temperature is sensed,
wherein the indication of the desired cabin temperature is displayed concurrently with and in substantial proximity to the indication of the current cabin temperature.

2. The method of claim 1, further comprising:
displaying the indication of the desired cabin temperature and the indication of the current cabin temperature according to a step-based display scheme including temperature steps displayed on the display,
wherein each temperature step represents a particular temperature within a temperature range.

3. The method of claim 2, further comprising:
displaying the indication of the desired cabin temperature using a first indicator that corresponds to a first temperature step of the temperature steps; and
displaying the indication of the current cabin temperature using a second indicator that corresponds to a second temperature step of the temperature steps.

4. The method of claim 3, wherein the first temperature step and the second temperature step are the same temperature step.

5. The method of claim 3, wherein the first indicator is a first icon and the second indicator is a second icon different from the first icon.

6. The method of claim 2, further comprising:
determining which temperature step of the temperature steps corresponds to the current cabin temperature based on the current cabin temperature sensed by the cabin temperature sensor, a total number of steps of the temperature steps, and a minimum and maximum temperature of the temperature range.

7. The method of claim 6, wherein the determining of which temperature step corresponds to the current cabin temperature is based further on a predetermined minimum and maximum temperature defining a temperature range within which the cabin of the vehicle is comfortable.

8. The method of claim 2, wherein each temperature step represents a particular temperature within a temperature range according to the following equation:
$${{T}_{STEP} ( i )}_{i = 1}^{m} = {T}_{SET , MIN} + \frac{( i - 1 ) ( {T}_{SET , MAX} - {T}_{SET , MIN} )}{( m - 1 )} ,$$
wherein T_{STEP}(i) is a temperature at temperature step i, m is a total number of steps of the temperature steps, T_{SET,MIN} is a minimum temperature in the temperature range, and T_{SET,MAX} is a maximum temperature in the temperature range.

9. The method of claim 1, further comprising:
displaying the indication of the desired cabin temperature using a first numerical value; and
displaying the indication of the current cabin temperature using a second numerical value.

10. The method of claim 1, further comprising:
determining a heating or cooling state of the vehicle; and
displaying an indication of the heating or cooling state on the display,
wherein the indication of the heating or cooling state is displayed concurrently with the indication of the desired cabin temperature and the indication of the current cabin temperature.

11. The method of claim 10, further comprising:
determining the heating or cooling state based on a position of temperature doors in the vehicle.

12. The method of claim 10, further comprising:
displaying the indication of the heating or cooling state using a color-based indicator.

13. The method of claim 12, further comprising:
updating the displayed indication of the heating or cooling state in real-time when a change of the heating or cooling state is determined by altering a color of the color-based indicator.

14. The method of claim 12, further comprising:
displaying the indication of the heating or cooling state according to a color-based display scheme including shades of color displayed on the display,
wherein each shade of color represents a particular heating or cooling state of a plurality of predetermined heating or cooling states.

15. The method of claim 12, wherein an indication of a heating state is displayed using a reddish-colored indicator, and an indication of a cooling state is displayed using a bluish-colored indicator.

16. The method of claim 10, wherein the determined heating or cooling state substantially corresponds to one of: maximum heating, partial heating, maximum cooling, partial cooling, and neutral.

17. The method of claim 1, further comprising:
determining a blower state of the vehicle; and
displaying an indication of the blower state on the display,
wherein the blower state represents whether an air conditioning system or a heater system is active, and
the indication of the blower state is displayed concurrently with the indication of the desired cabin temperature and the indication of the current cabin temperature.

18. The method of claim 17, further comprising:
displaying the indication of the blower state using a text-based indicator.

19. The method of claim 1, further comprising:
determining a desired driver-side cabin temperature based on input received via a first cabin temperature setting means;
determining a desired passenger-side cabin temperature based on input received via a second cabin temperature setting means; and
displaying an indication of the desired driver-side cabin temperature and an indication of the desired passenger-side cabin temperature on the display.

20. A system comprising:
a cabin temperature sensor that senses a current cabin temperature in a cabin of a vehicle;
a cabin temperature setting means that receives input indicative of a desired cabin temperature;
a display in the vehicle that displays information; and
a controller that controls the display and thereby causes the display to: i) display an indication of the desired cabin temperature, ii) display an indication of the current cabin temperature, and iii) update the displayed indication of the current cabin temperature in real-time when a change of the current cabin temperature is sensed,
wherein the indication of the desired cabin temperature is displayed concurrently with and in substantial proximity to the indication of the current cabin temperature.
